(19) United States
(12) Patent Application Publication
(10) Pub. No.: US 2014/0278226 A1
(43) Pub. Date: Sep. 18, 2014

(54) Method for Characterization of Vehicle Support Surfaces

(71) Applicant: Hunter Engineering Company, St. Louis, MO (US)

(72) Inventors: Michael T. Stieff, Wentzville, MO (US); James W. McClenahan, St. Louis, MO (US); J. Kaleb Silver, St. Peters, MO (US); Timothy A. Strege, Sunset Hills, MO (US); Nicholas J. Colarelli, III, Creve Coeur, MO (US)

(73) Assignee: Hunter Engineering Company, St. Louis, MO (US)

(21) Appl. No.: 14/203,911

(22) Filed: Mar. 11, 2014

Related U.S. Application Data
(60) Provisional application No. 61/777,421, filed on Mar. 12, 2013.

(51) Int. Cl. G01B 11/275

(52) U.S. Cl. CPC G01B 11/2755
USPC 702/154; 702/150

(57) ABSTRACT

A method for characterizing the surface over which a vehicle is to be rolled during a rolling compensation procedure. A set of wheel alignment angle sensors are mounted to the rearmost fixed axle of a vehicle which is then backed onto the floor surface to be characterized, and rolled in reverse over the region of the floor surface generally traversed during a rolling compensation procedure. As the vehicle is rolled in reverse, a pair of wheel alignment angle sensors temporarily positioned at selected points on the floor surface measure a distance to the wheel-mounted alignment angle sensors, which in turn, are acquiring camber angle measurements. The resulting set of measurements is stored in an accessible data storage device, characterizing the camber altering contours of a path across the floor surface.

### CROSS-REFERENCE TO RELATED APPLICATIONS

The present application is related to, and claims priority from, U.S. Provisional Patent Application Ser. No. 61/777,421 filed on Mar. 12, 2013, and which is herein incorporated by reference.

### STATEMENT REGARDING FEDERALLY SPONSORED RESEARCH

Not Applicable.

### BACKGROUND OF THE INVENTION

The present application is related to vehicle wheel alignment measurement procedures, and in particular, to a procedure for utilizing the sensors of a vehicle wheel alignment system to characterize a portion of a vehicle service bay floor surface over which a vehicle rolls during a vehicle service procedure.

In any wheel alignment system, the orientation of the axis of rotation of the individual vehicle wheel assemblies must be determined before alignment angles associated with the wheel assemblies can be measured and/or calculated. In an ideal application, sensors associated with a vehicle wheel alignment system would always be mounted to the wheel assemblies such that each sensor is precisely aligned with the axis of rotation of the associated wheel assembly on which it is mounted, and measurements can be directly obtained.

While this can be achieved through the use of highly accurate machined components and special “no-comp” mounting adapters for securing each sensor to the associated wheel assembly, it is not always the optimal solution. When a “no-comp” wheel adapter is mounted on the wheel assembly in a precise and predetermined mounting using machined provisions on either a wheel or brake hub, the axis of the wheel adapter is expected to be coaxial with the axis of rotation of the wheel assembly. A pre-compensated vehicle wheel alignment sensor is then mounted in the aligned socket of the wheel adapter, and measurements can be obtained without any further compensation steps. However, any damage to the wheel adapter, or foreign objects/debris in the interface between the wheel adapter and the machined provisions on the wheel assembly or brake hub will cause erroneous readings. Furthermore, due to the precision machining required, this method is expensive for both the vehicle manufacturer and the alignment equipment manufacturer due.

As an alternative to “no-comp” mounting adapters, it is possible to identify and accommodate the reality of imperfections introduced by mounting a sensor onto a wheel assembly. One method to account for these imperfections utilizes a compensation procedure which involves observing changes in measured camber and/or a toe angles measured by a vehicle wheel alignment sensor at different rotational positions of an associated wheel assembly on which the sensor is mounted with a traditional mounting adapter. These rotational positions may be observed either by jacking the vehicle above the supporting surface such that the individual wheel assemblies are free to rotate while suspended in the air, or by rolling the vehicle over a flat surface a sufficient distance to acquire the necessary rotational measurements. The changes which are caused by any eccentricity in the mounting of each sensor to an associated wheel assembly are defined by an observable sinusoidal pattern, enabling subsequent measurements to be suitably compensated at any rotational position of the wheel assemblies.

When performing alignment measurements on heavy duty vehicles, such as multi-axle trucks, the size of the vehicle can be a factor in determining what type of wheel alignment adapters and procedures are to be utilized. For example, it is common practice to utilize the “no-comp” mounting adapters with heavy duty vehicles, despite the increased cost of such adapters, because it can difficult to utilize either a jacking or rolling compensation procedure with these vehicles. For example, a heavy duty vehicle can be difficult (and dangerous) to elevate above a supporting surface to allow the individual wheel assemblies to be freely rotated while suspended in the air, often precluding the use of this procedure for compensating alignment sensors. Rolling the heavy duty vehicle to obtain compensation measurements is similarly avoided, but for a different reason. When undergoing service procedures, heavy duty vehicles are generally not disposed on precision flat surfaces such as vehicle lift racks. Rather, these vehicles are typically serviced over a service pit or access area, while resting directly on the adjacent floor of the vehicle service bay or garage, such as shown in FIG. 1, These floors may have uneven or sloped surfaces. Imperfections or inclinations in the surface over which a vehicle is rolled during a rolling compensation procedure can introduce unknown errors into the compensation measurements, rendering the resulting measurements useless. Hence, in order to utilize a rolling compensation procedure in which the vehicle is rolled across a floor surface during the measurement phase, it is currently necessary to either ensure the floor surface is uniformly level to within a tolerance, or to utilize specialized and complex surveying equipment to “map” the surface contours of the floor in advance of the rolling compensation procedures. Neither solution is efficient or economical.

Accordingly, it would be advantageous to provide a method for quickly and efficiently characterizing the supporting surface over which a vehicle is to be rolled during a rolling compensation procedure, enabling imperfections, inclinations, and other invariant deviations from an ideal planar surface to be identified and compensated for in any subsequent measurements acquired from vehicle wheel alignment angle sensor units.

It would be further advantageous to provide a method for characterizing the supporting surface over which a vehicle is rolled which does not require the use of additional specialized sensors or equipment, and which can be accomplished using the same vehicle wheel alignment sensors, which are utilized to measure alignment angles associated with a vehicle undergoing service.

### BRIEF SUMMARY OF THE INVENTION

Briefly stated, the present disclosure sets forth a method for characterizing the supporting floor surface over which a vehicle is to be rolled during a rolling compensation procedure, enabling imperfections, inclinations, and other invariant deviations from an ideal planar surface to be identified and compensated for in any subsequent measurements acquired from vehicle wheel alignment angle sensor units. The process begins by mounting a set of wheel alignment angle sensors which are capable of directly measuring at least camber alignment angles, to the outer wheel assemblies on the rearmost fixed (non-steered) axle of a vehicle. The vehicle is then backed onto the floor surface to be characterized, and rolled in reverse over the region of the floor surface generally traversed during a rolling compensation procedure, towards a set of turn plates disposed on the floor surface for receiving the front steered wheel assemblies of a vehicle. As the vehicle is rolled in reverse, a pair of wheel alignment angle sensors temporarily positioned on the front turn plates measure distances to the alignment angle sensors mounted to the wheel assemblies, which in turn, are concurrently acquiring measurements of camber angles which are induced by the contour of the floor surface beneath the wheel assemblies. The resulting set of measurements associates acquired camber angle measurements with corresponding linear distance measurements from the sensors disposed on the front turn plates. The set of measurements is stored in an accessible data storage device, effectively characterizing the contours of the floor surface over which the wheel assemblies of the rearmost fixed axle of the vehicle have traversed in a generally linear path towards the front turn plates. Anticipating that the floor surface contours will not change, individual measurements of vehicle wheel alignment angles acquired from sensors mounted to vehicle wheel assemblies disposed on the characterized portion of the floor surface can be subsequently offset or compensated for the observed amount of floor-induced camber inclination at their specific locations.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is a top plan view of a conventional heavy-duty vehicle pit-style inspection bay, having a pair of parallel floor surfaces over which a vehicle rolls and a pit-mounted front turn plate structure for receiving the front steered wheels of a vehicle;

FIG. 2 is an illustration of a position in a service area of a vehicle employed during a floor surface characterization method of the present disclosure utilizing vehicle wheel alignment angle sensors;

FIG. 3 is an illustration similar to FIG. 2, utilizing optical targets and an imaging system;

FIG. 3A illustrates a variation of the embodiment of FIG. 3, in which an additional set of optical targets are disposed at the reference position; and

FIG. 4 is a flow chart illustrating the steps of an illustrative procedure of the present disclosure.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

Turning to the Figures, and to FIGS. 2 and 3 in particular, a method for characterizing the floor surfaces 100 in a service bay over which a vehicle 10 is to be rolled during a service procedure, such as a rolling compensation procedure for sensors units 200, such as vehicle wheel alignment angle sensors (as seen in FIG. 2) or optical targets (as seen in FIG. 3), mounted to vehicle wheel assemblies 12 is illustrated. The process as set forth enables elevation changes, imperfections, inclinations, and other invariant deviations in a surface such as a service bay floor 100 from an ideal planar surface, which are present in the path over which the vehicle 10 travels during a service procedure, to be characterized and stored. Using the stored characterization data, the induced effects of the surface characteristics can be compensated for in any subsequent measurements acquired from sensor units 200 associated with vehicle wheel assemblies 12 positioned on the characterized portion of the surfaces 100.

It will be understood that while the term floor surface 100 is used here in primarily in reference to the solid foundation surface of the vehicle service bay, the methods set forth herein can be utilized to characterize any solid surface over which a vehicle 12 rolls or a calibration fixtures can be positioned, including vehicle lift runway surfaces, gratings, elevated ramps, plates, rigid mats, etc. without departing from the scope of the present disclosure. Accordingly, the use of the term “floor surface” or “surface” as used herein in used in a general context, and is not limiting to any specific type of rigid material or solid structure over which a vehicle 12 is to be rolled.

One embodiment of a floor characterization process of the present invention is illustrated with reference to the steps of FIG. 4. The process begins (Box 50) by positioning two sets of vehicle wheel alignment angle sensors 200, 202 as illustrated in FIG. 2. At a minimum, the wheel alignment angle sensors 200, 202 must be capable of measuring a distance between associated sensors in each set on common sides of the vehicle 10, together with at least the camber angles of vehicle wheel assembly 12 on which one set 202 is mounted. These measurements can be acquired using a variety of known techniques, such as optical measurements for distance and gravity-referenced inclination measurements for camber, but are not limited to such. Exemplary sensors, such as shown at FIG. 2, are the DSP-700 series vehicle wheel alignment sensors manufactured and sold by Hunter Engineering Company of St. Louis, Mo.

Alternatively, measurements can be determined using imaging sensors 300 and optical targets 302 associated with a machine vision vehicle wheel alignment system, such as shown in FIG. 3, in which the imaging sensors 300 may replace one set of angle sensors 200, while optical targets 302 will replace the other set of angle sensors 202. Alternatively, as shown in FIG. 3a, optical targets 302 may replace both sets of angle sensors 200, 202, and the imaging sensors 300 be disposed to acquire images of all the optical targets from which the necessary measurements can be determined.

The first set of sensors 200 is mounted to a suitable fixture or stand 204 which is temporarily placed (Box 52) in line with the vehicle travel pathway, at a determinable or identified reference position or line 400. The first set of sensors 200 is provided with a suitable field of view to acquire or facilitate distance measurements associated with the vehicle 10 moving towards or away from the reference position 400. When utilized to characterize the surfaces 100 of a vehicle service bay employed for vehicle wheel alignment measurements, the selected reference position 400 is preferably a line located across the front turn plates 500 on the floor of the vehicle service bay, with each of the first set of sensors 200 positioned to view at least one wheel assembly 12 on a respective lateral side of a vehicle 10 positioned on the floor surface 100 to be characterized. If a machine vision vehicle wheel alignment system is being utilized, the location of the imaging sensors 300 (as in FIG. 3), or a set of reference targets 302 in a field of view of the imaging sensors 300 (as in FIG. 3a), establishes the determinable or identified reference position 400.

The selected reference position 400, such as the location of the front turn plates 500, is defined as “level” and establishes a relative reference for the subsequent floor characterization data, anticipating that vehicles 10 undergoing service within the vehicle service bay will each generally traverse the same pathway on the surface 100 towards and away from the selected reference position 400 or front turn plates 400. This pathway can be generally represented as shown in FIG. 2, as two parallel rectangular regions of the floor surface 100, each having a width which is approximately equal to the width of wheel assemblies 12 on one end of a vehicle axle, which begins approximately 100″ from the selected position 400 or front turn plates 500 (i.e. approximately where the rear axles 14 of a vehicle would be disposed if the front axle 16 was positioned at the selected position or on the front turn plates 500), and which extends to approximately 600″ from the front turn plates 500 (i.e., approximately the maximum wheelbase length of a vehicle to be serviced in the service bay combined with a necessary rolling distance for rolling compensation procedures). Those of ordinary skill in the art will recognize that the specific regions of a vehicle service bay floor surface 100 to be characterized may vary depending upon the size of the service bay, and the particular wheelbase configuration and size of the vehicles 10 which will be serviced in the service bay.

As best seen in FIG. 2, the second set of vehicle wheel alignment angle sensors 202 is mounted (Box 54) to the outer wheel assemblies 12 of the rearmost fixed (non-steered) axle 14 of a vehicle 10 which is typical of the type of vehicles to be serviced in the service bay. Preferably, the vehicle 10 is positioned in the service bay in a reversed orientation (Box 56), with the rearmost fixed axle 14 positioned closest to the front turn plate 500 or reference position 400. The second set of vehicle wheel alignment sensors 202 is capable of measuring at least the camber angles associated with the wheel assemblies 12 upon which they are mounted, and may operate cooperatively with the first set of sensors 200 disposed on the turn plates 500 to determine relative distances. The rearmost fixed axle 14 of the vehicle 10 is the preferred mounting location for the second set of vehicle wheel alignment sensors 202, as the axle is not subject to steering-induced angular changes during rolling movement, and when viewed from the rear of the vehicle 10, provides a generally unobstructed line of sight to the wheel assembly mounted sensors or optical targets.

While the present disclosure is described as utilizing the outer wheel assemblies 12 on the rearmost fixed axle 14 of a vehicle 10 as the mounting point for the second set of sensors 202 or optical targets, one of ordinary skill in the art will recognize that the mounting point could also be wheel assemblies on any axle of a vehicle or fixture. Additionally, a movable fixture or framework (not shown), such as a calibration bar utilized in the calibration of vehicle wheel alignment systems, could be utilized in place of the vehicle 10 to support the second set of sensors 202 or optical targets. However, such a movable fixture or framework might not accurately reproduce the effects of floor surface imperfections or deviations from level as experienced by vehicle wheel alignment sensors or optical targets mounted when on actual vehicle wheel assemblies 12.

Once the second set of sensors 202 is mounted to the vehicle wheel assemblies 12 or movable fixture, any required compensation procedures necessary to account for runout in the mounting of the sensors are carried out. These may necessitate jacking the vehicle 10 above the supporting surface 100 to enable free rotation of the vehicle wheel assembly 12 onto which the sensors 202 are mounted, as is convention in the vehicle wheel alignment industry. Alternatively, if the sensors 202 are mounted to the vehicle wheel assemblies 12 utilizing “no-comp” adapters, it is assumed that there is no runout between the wheel axis of rotation and the sensor axis, and no additional compensation step is required.

With the vehicle 10 backed onto the floor surface 100 to be characterized, and the rearmost axle 12 positioned at the closest point on the surface 100 to be characterized towards the front turn plate 500 or reference position 400, the vehicle 10 is rolled (Box 58) forward (i.e. away from the front turn plates) over the region of the floor surface 100 generally traversed during the a vehicle service procedure such as a rolling compensation procedure. The rolling movement is directed away from the first set of sensors 200 disposed at the selected position 400 or set of front turn plates 500. Those of ordinary skill in the art will recognize that this process may be carried out in reverse, i.e., that the vehicle 10 may be initially disposed at a furthest point on the floor surface from the front turn plates 500 or reference point 400, and rolled in reverse towards the front turn plates or reference points without altering the end results.

Regardless of the direction of rolling movement, the vehicle 10 (or calibration fixture) is moved across the entire region of the floor surface 100 which would be utilized during a vehicle service procedure or rolling compensation procedure. As the vehicle is rolled, the first set of wheel alignment angle sensors 200, positioned at the selected reference position 400 or on the front turn plates 500, are utilized in conjunction with the second set of sensors 202 to acquire measurements which are representative of the distances to each sensor in the second set of wheel-mounted alignment angle sensors 202. During the movement, the wheel-mounted alignment angle sensors 202, acquire at least camber angle measurements for the associated wheel assemblies 12 upon which they are mounted.

Those of ordinary skill will recognize that the specific manner in which the characterization data is acquired may be varied from that which is described without departing from the scope of the disclosure. For example, the wheel mounted sensors 202 themselves may be configured to acquire both the camber angle measurements and the distance measurements (by referencing the location of the fixture mounted sensors 200). Alternatively, if a machine vision vehicle wheel alignment system is employed, with optical targets 302 disposed at the reference position, mounted to the vehicle wheel assemblies 12, or to a movable calibration fixture (not shown) in place of the angle sensors 200, 202, the characterizing data, in the form of either angular data, or data associated directly with floor surface elevation, may be determined by processing images of the optical targets 302 acquired by imaging sensors 300 for a plurality of positions of the optical targets 302 during the movement procedure.

If a movable calibration fixture without wheels (not shown) is utilized in place of a vehicle axle 14 to support the sensors or optical targets, the calibration fixture may be “walked” or moved to a plurality of positions along the length of the floor surface 100 to be characterized in place of the rolling movement. Characterization data, such as angular orientation data or elevation data for the observed optical targets or angle sensors at each end of the calibration fixture, is acquired at each point at which the calibration fixture is disposed, and is utilized to directly “map” the contours of the floor surface 100 over the two parallel regions.

The resulting set of measurements associates each acquired data value, such as a camber angle measurement, with a corresponding linear distance measurement (or spatial position) relative to the selected reference position 400 or the front turn plates 500 to characterize the floor surface 100 (Box 60). The combined set of measurements is then stored (Box 62) in an accessible data storage device (not shown), effectively characterizing, in terms of either elevation changes and/or angular deviations, the contours of the floor surface 100 over which the wheel assemblies 12 of the rearmost fixed axle 14 of the vehicle (or mobile fixture) have traversed. This stored data may characterize each of the parallel floor surface regions 100 individually, or may characterize the net effect the contour of the parallel floor surface regions will introduce to measured alignment angles of individual wheel assemblies 12 associated with a common axle 14, 16 of a vehicle 10 when positioned on each of the parallel floor surface regions 100. Those of ordinary skill in the art will recognize that, for characterization data obtained at discrete points on the floor surface, positions on the floor surface between two or more measurement points may be characterized by interpolation using any suitable mathematical process and appropriate assumptions for the relative smoothness of the floor surface.

Anticipating that the floor surface contours will not change over time for solid or rigid surfaces, individual measurements of vehicle wheel alignment angles subsequently acquired from sensors or optical targets mounted to vehicle wheel assemblies 12 positioned at discrete points on the characterized portion of the floor surface 100 during a measurement procedure can be offset or compensated for at least the known amount of floor-induced camber inclination.

While described in the context of a heavy-duty vehicle service bay, such as shown at FIG. 1, those of ordinary skill in the art will recognize that the procedures of the present disclosure can be utilized to characterize the stable surface of any type of vehicle service bay, inspection lane, or roadway over which a vehicle 10 is moved. Once characterized, subsequent alignment measurements acquired while a vehicle is disposed on the characterized portion of the floor surface 100 can be compensated or offset for the observed or interpolated characteristics of the floor surface at the associated position. Additional portions of the floor surface can be characterized using the same procedures by acquiring camber angle and distance measurements for portions of the floor surface which are laterally offset from those which have already been characterized, such as by employing a vehicle having a different axle width, or by laterally displacing the vehicle path of travel during a repetition of the characterization procedure. The resulting characterization data may be merged with characterization data previously acquired to produce a single characterization mapping for the combined surface area of the floor.

The present disclosure can be embodied in-part in the form of computer-implemented processes and apparatuses for practicing those processes. The present disclosure can also be embodied in-part in the form of computer program code containing instructions embodied in tangible media, or another computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A method for characterizing a surface over which a vehicle is rolled during a vehicle service procedure, comprising:
acquiring characterization data measurements at a plurality of points along a portion of said surface traversed by the wheel assemblies of a vehicle;
associating each of said acquired characterization data measurements with a unique point on said surface; and
establishing a characterization of said portion of said surface using said acquired characterization data measurements and said associated unique points, said characterization comprising compensation data for vehicle alignment angle measurements acquired for wheel assemblies positioned on said characterized portion of said surface.

2. The method of claim 1 wherein said characterization data measurements are representative of surface-induced camber angle inclinations in vehicle wheel assemblies.

3. The method of claim 1 wherein said characterization data measurements are representative of elevation.

4. The method of claim 1 wherein said steps of acquiring, associating, and establishing are repeated at least once, for a portion of said surface which is laterally offset from each previous characterized portion of said surface.

5. The method of claim 1 further including the step of utilizing said characterization to compensate at least one subsequently acquired angle measurement associated with a vehicle wheel assembly disposed on said characterized portion of said surface.

6. The method of claim 1 further including the step of utilizing said characterization to compensate measurements associated with angle measurements acquired during a rolling compensation procedure by an alignment angle sensor mounted to a vehicle wheel assembly disposed on said characterized portion of said surface.

7. The method of claim 1 wherein said step of associating each of said acquired measurements with a unique point on said surface includes determining, for each of said unique points, a spatial relationship relative to, or a distance from, an established reference.

8. The method of claim 7 wherein said established reference is associated with the location of a set of turn plates disposed at a fixed position relative to said surface.

9. The method of claim 7 further including the steps of:
providing a vehicle, said vehicle having at least one rearmost fixed (un-steered) axle;
mounting an alignment angle sensor to each outermost wheel assembly of said at least one rearmost axle; and
wherein said step of acquiring includes rolling said vehicle over said portion of said surface while acquiring said characterization data measurements from said alignment angle sensors, said acquired measurements representative of at least camber angle inclinations from each of said alignment angle sensors at a plurality of points on said surface.

10. The method of claim 7 further including the steps of:
providing a vehicle, said vehicle having at least one rearmost fixed (un-steered) axle;
mounting an optical target to each outermost wheel assembly of said at least one rearmost axle;
wherein said step of acquiring includes rolling said vehicle over said portion of said surface while acquiring images of each of said optical targets with an imaging system;
processing said acquired images to determine said characterization data measurements, said characterization data measurements representative of at least camber angle inclinations associated with each of said outermost wheel assemblies at a plurality of points on said surface; and
processing said acquired images to determine for each of said plurality of points on said surface, said spatial relationship relative to, or said distance from, said established reference.

11. The method of claim 10 wherein said vehicle is rolled in a reverse direction towards said established reference, with said rearmost fixed axle oriented towards said established reference.

12. The method of claim 10 wherein said vehicle is rolled in a forward direction away from said established reference, with said rearmost fixed axle oriented towards said established reference.

13. The method of claim 10 wherein said imaging system is disposed at a determined location relative to said established reference.

14. The method of claim 10 further including the steps of disposing at least one optical target at said established reference;
acquiring at least one image of said optical target at said established reference with said imaging system; and
processing said at least one acquired image of said optical target at said established reference to determine said location of said imaging system relative to said established reference.

15. The method of claim 1 wherein said acquired measurements are associated with a spatial orientation of at least one optical target.

16. The method of claim 1 wherein said surface includes a pair of spaced-apart parallel surface regions, and wherein said established characterization is representative of angular deviations introduced into angular measurements of vehicle wheel assemblies on an a vehicle axle while said vehicle axle is disposed across said parallel surface regions, with at least one vehicle wheel assembly on each of said parallel surface regions.

17. The method of claim 1 wherein said step of acquiring measurements includes:
providing at least one optical target mounted to a fixture;
acquiring, with a machine vision vehicle measurement system, a plurality of images of said optical target with said fixture positioned at discrete points on said portion of said floor surface; and
processing, at said machine vision vehicle measurement system, said acquired plurality of images to evaluate a spatial position and/or orientation of said at least one optical target at each position of said fixture to identify at least an elevation measurement associated with each of said positions.

18. The method of claim 17 wherein said characterization data measurements are representative of at least one surface-induced angular inclination or elevation measurement.

19. A method for measuring at least one alignment angle associated with a vehicle disposed on a characterized surface, comprising:
acquiring measurement data associated with said at least one alignment angle;
acquiring data representative of a position of the vehicle on said characterized surface when said measurement data is acquired;
retrieving characterization data for said position; and
utilizing said retrieved characterization data together with said acquired measurement data to determine a compensated measure of said at least one alignment angle.

20. The method of claim 19 wherein said at least one alignment angle is a camber angle, and wherein said characterization data is camber offset data representative of camber deviations imparted to said vehicle by said characterized surface.
